(19) United States
(12) Patent Application Publication
(10) Pub. No.: US 2025/0087191 A1
(43) Pub. Date: Mar. 13, 2025

(54) Electronic Percussion Instrument

(71) Applicant: Ef-Note Inc., Hamamatsu-shi (JP)

(72) Inventor: Yoshiaki MORI, Hamamatsu-shi (JP)

(21) Appl. No.: 18/953,256

(22) Filed: Nov. 20, 2024

Related U.S. Application Data
(63) Continuation of application No. PCT/JP2023/019922, filed on May 29, 2023.

(30) Foreign Application Priority Data
Jun. 2, 2022 (JP) 2022-090521

(51) Int. Cl. G10H 3/14; G10D 13/10

(52) U.S. Cl. CPC G10H 3/146; G10D 13/26; G10H 3/143; G10H 2230/321; G10H 2250/435

(57) ABSTRACT

An electronic percussion instrument has a body with a hitting surface that a player can hit. Piezoelectric elements are mounted on respective mounting surfaces Sa formed in the body and are configured to convert vibration generated by a hit on the hitting surface to an electrical signal. The signals have higher output characteristics in vibration in a direction perpendicular to the mounting surfaces than in vibration in a direction parallel to the mounting surfaces. The electronic percussion instrument outputs the electrical signal generated by the piezoelectric elements. The mounting surfaces are inclined from a horizontal plane to a vertical direction β toward a center of the body. The piezoelectric elements are mounted on a concentric circle at regular intervals about a central axis of the body.

### CROSS-REFERENCE TO RELATED APPLICATIONS

This application is a continuation of International Application PCT/JP2023/019922, filed May 29, 2023, which claims priority to Japanese Application No. 2022-090521, filed Jun. 2, 2022. The disclosures of the above applications are incorporating herein by reference.

### FIELD

The present disclosure relates to an electronic percussion instrument that can output an electrical signal generated by a piezoelectric element.

### BACKGROUND

A known electronic cymbal is an electronic percussion instrument as disclosed in e.g., Japanese Unexamined Patent Application Publication No. 2005-331972. It includes an electronic cymbal body with a pad having a hitting surface that a player can hit. A frame supports a back surface side of the pad. A vibration sensor detects a hit on the hitting surface of the pad. An output cable outputs a detection signal detected by the vibration sensor to the outside. When a player hits the hitting surface of the electronic cymbal body with a stick, the vibration sensor detects the hit. External output is performed and similar performances to acoustic cymbal performances can be achieved.

### SUMMARY

However, in the related art described above, a piezoelectric element is used as a vibration sensor. Thus, the following problem arise. Specifically, the piezoelectric element is comprised of an element that is mounted on a mounting surface formed in the body. It converts vibration generated by a hit on a hitting surface to an electrical signal. It has higher output characteristics in vibration in a direction perpendicular to the mounting surface than in vibration in a direction parallel to the mounting surface. Thus, when a hit is made in a direction parallel to the mounting surface, an electrical signal cannot be favorably generated and a desired output may not be produced.

However, in an electronic cymbal where multiple piezoelectric elements are mounted, the output by vibration in a vertical direction is uniformized. However, the output by vibration in nearly a horizontal direction is uneven and becomes unstable. Such a problem arises not only in an electronic cymbal, but also in an electronic musical instrument in general that detects a hit on a hitting surface by a piezoelectric element and outputs the hit. The present applicant has intensively studied to eliminate this problem.

The present disclosure is made in consideration of the above-described situation. It is an object of the present disclosure to provide an electronic percussion instrument that, upon a hit on the hitting surface in any of various directions, can stably and reliably convert the hit to an electrical signal by a piezoelectric element and can output the electrical signal.

The disclosure is an electronic percussion instrument comprising: a body having a hitting surface that a player can hit. Piezoelectric elements are mounted on respective mounting surfaces formed in the body and configured to convert vibration generated by a hit on the hitting surface to an electrical signal. The signals have higher output characteristics in vibration in a direction perpendicular to the mounting surfaces than in vibration in a direction parallel to the mounting surfaces. The electronic percussion instrument is capable of outputting the electrical signal generated by the piezoelectric elements. The mounting surfaces are formed of surfaces inclined from a horizontal plane to a vertical direction toward a center of the body. The piezoelectric elements are mounted on a concentric circle at regular intervals about a central axis of the body.

The disclosure is the electronic percussion instrument where the piezoelectric elements are more than two in number and mounted on a concentric circle at regular intervals about the central axis of the body.

The disclosure is the electronic percussion instrument where a shape about the central axis including a predetermined region of the body is regarded as a virtual conical shape. The mounting surfaces are formed on a concentric circle about the central axis on a lateral surface of the virtual conical shape. The mounting surfaces are provided in a circumferential direction on an outer circumferential surface or an inner circumferential surface of the body.

The disclosure is the electronic percussion instrument where the mounting surfaces are formed in a circumferential direction on an outer circumferential surface or an inner circumferential surface of the body. They are comprised of planar surfaces corresponding to mounting portions of the piezoelectric elements.

The disclosure is the electronic percussion instrument where the mounting surfaces have substantially the same shape and dimension as an external shape of the piezoelectric elements.

The disclosure is the electronic percussion instrument where a buffer member is attached to the piezoelectric elements. The buffer member is brought into contact with and mounted on a corresponding one of the mounting surfaces.

According to the disclosure, the mounting surfaces are formed of surfaces inclined from a horizontal plane to a vertical direction toward a center of the body. The piezoelectric elements are mounted on a concentric circle at regular intervals about a central axis of the body. Thus, even if the hitting surface is hit in any of various directions, the hit can be stably and reliably converted to an electrical signal by the piezoelectric elements. The electrical signal can be output.

According to the disclosure, the piezoelectric elements are more than two in number and mounted on a concentric circle at regular intervals about the central axis of the body. Thus, a hit on the hitting surface can be stably converted to an electrical signal by the piezoelectric elements. The electrical signal can be uniformly output for hits in various directions.

According to the disclosure, when a shape about the central axis including a predetermined region of the body is regarded as a virtual conical shape, the mounting surfaces are formed on a concentric circle about the central axis on a lateral surface of the virtual conical shape. The mounting surfaces are provided in a circumferential direction on an outer circumferential surface or an inner circumferential surface of the body. Thus, the piezoelectric elements can receive the vibration caused by a hit on the hitting surface more uniformly over the entire area of the hitting surface. Thus, a variation can be prevented in the output of electrical signal due to a difference in hitting region.

According to the disclosure, the mounting surfaces are formed in a circumferential direction on an outer circumferential surface or an inner circumferential surface of the body. They are comprised of planar surfaces corresponding to mounting portions of the piezoelectric elements. Thus, the piezoelectric elements can be stably fixed to the mounting surfaces.

According to the disclosure, the mounting surfaces have substantially the same shape and dimension as an external shape of the piezoelectric elements. Thus, at the time of mounting work of the piezoelectric elements, the mounting positions of the piezoelectric elements on the inner circumferential surface of the body can be accurately recognized. Accordingly, the positioning accuracy of the piezoelectric elements can be improved. Specifically, the piezoelectric elements are mounted corresponding to the mounting surfaces. Thus, the positioning of the piezoelectric elements is automatically made, and the positioning accuracy can be improved.

According to the disclosure, a buffer member is attached to the piezoelectric elements. The buffer member is brought into contact with and mounted on the corresponding mounting surface. Thus, it is possible to prevent damage to the piezoelectric elements by the vibration generated by a hit.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of the entire exterior of an electronic cymbal according to an embodiment of the present disclosure.

FIG. 2 is a three-side view of the body of the electronic cymbal.

FIG. 3 is a sectional view taken along line III-III in FIG. 2.

FIG. 4 is an exploded perspective view of the body of the electronic cymbal.

FIG. 5 is a bottom view of the body with a covering member removed.

FIG. 6 is a bottom view of the body with the covering member and piezoelectric elements removed.

FIG. 7 is a sectional view taken along line VII-VII in FIG. 6.

FIG. 8 is a schematic view of a piezoelectric element mounted on the electronic cymbal.

FIG. 9 is a sectional view taken along line IX-IX in FIG. 8.

FIG. 10 is a three-side view of a pad of the electronic cymbal.

FIG. 11 is a perspective view of the pad as seen from below.

FIG. 12 is a three-side view of a frame of the electronic cymbal.

FIG. 13 is a perspective view of the frame as seen from below.

FIG. 14 is a three-side view of the covering member of the electronic cymbal.

FIG. 15 is a perspective view of the covering member as seen from below.

FIG. 16 is a perspective view of the case where three piezoelectric elements are mounted in an electronic cymbal according to another embodiment of the present disclosure.

FIG. 17 is a perspective view of the case where five piezoelectric elements are mounted in an electronic cymbal according to another embodiment of the present disclosure.

FIG. 18 is a schematic view of a mounting manner for piezoelectric elements of an electronic percussion instrument according to another embodiment of the present disclosure.

FIG. 19 is schematic view of a mounting manner for piezoelectric elements of an electronic percussion instrument according to another embodiment of the present disclosure.

FIG. 20 is schematic view of a mounting manner for piezoelectric elements of an electronic percussion instrument according to another embodiment of the present disclosure.

FIG. 21 is a sectional schematic view of a piezoelectric element mounted on the electronic cymbal.

FIG. 22 is a three-side view of a buffer member attached to a piezoelectric element of the electronic cymbal.

### DETAILED DESCRIPTION

Hereinafter, embodiments of the present disclosure will be concretely described with reference to the drawings.

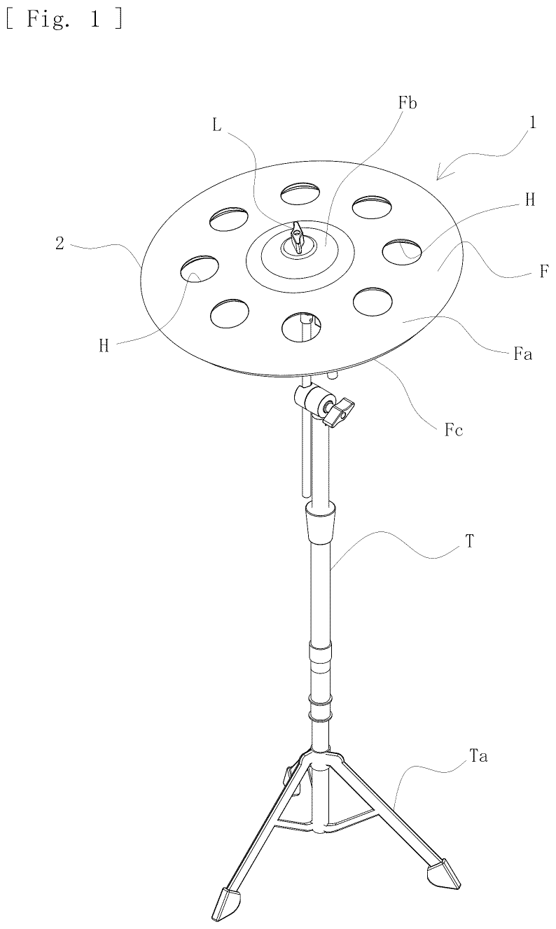

An embodiment of the present disclosure will be specifically described below with reference to the drawings. As illustrated in FIGS. 1 to 6, an electronic cymbal according to the present embodiment includes a body 1, including a pad 2, and a frame 3 with a hitting surface F that a player can hit. Piezoelectric elements 4 (vibration sensors) are mounted on an inner circumferential surface S of the frame 3 in the body 1. A covering member 8 is included.

As illustrated in FIG. 1, the body 1 is supported at a predetermined height by a supporting stand T vertically extended from a stand leg part Ta. The body 1 includes a pad 2 having a hitting surface F that a player can hit. A frame 3 supports the back surface side of the pad 2. In addition, a plurality of openings Ha are formed in the pad 2, a plurality of openings Hb are formed in the frame 3. These openings Ha and openings Hb communicate with each other to constitute opening H of the body 1. Note that symbol L in FIG. 1 indicates a tightening member for tightening and fixing the body 1 to the supporting stand T.

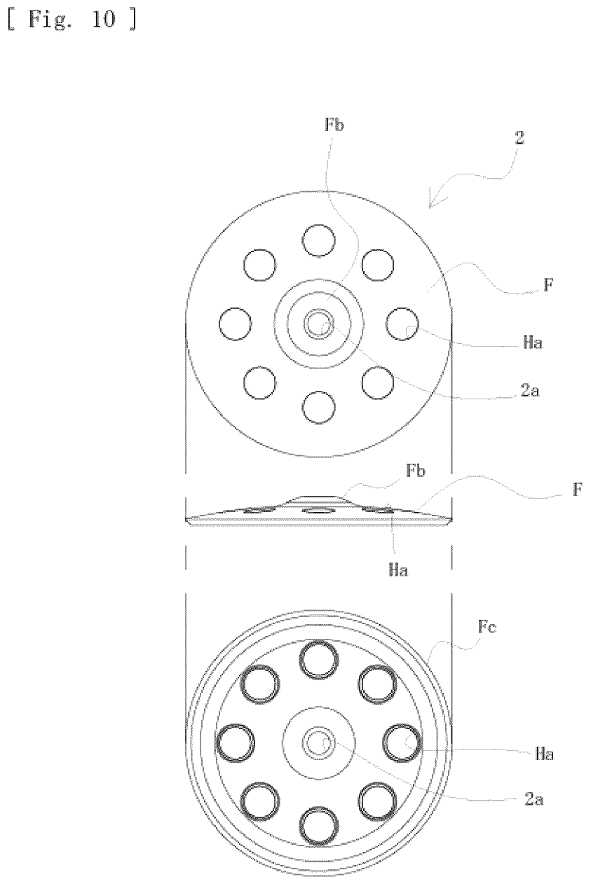

The pad 2 is made of a material such as a rubber material or a soft resin (a silicone rubber in the present embodiment) that can be hit with a stick. As illustrated in FIGS. 10 and 11, the pad 2 includes a disk-shaped member with, at a center position, an insertion hole 2a that receives the supporting stand T. The hitting surface F, formed in the upper surface of the pad 2, includes a cup part Fb, bulging at the center of the pad 2, an edge part Fc, in the circumferential edge of the pad 2, and a bow part Fa, in a region between the cup part Fb and the edge part Fc.

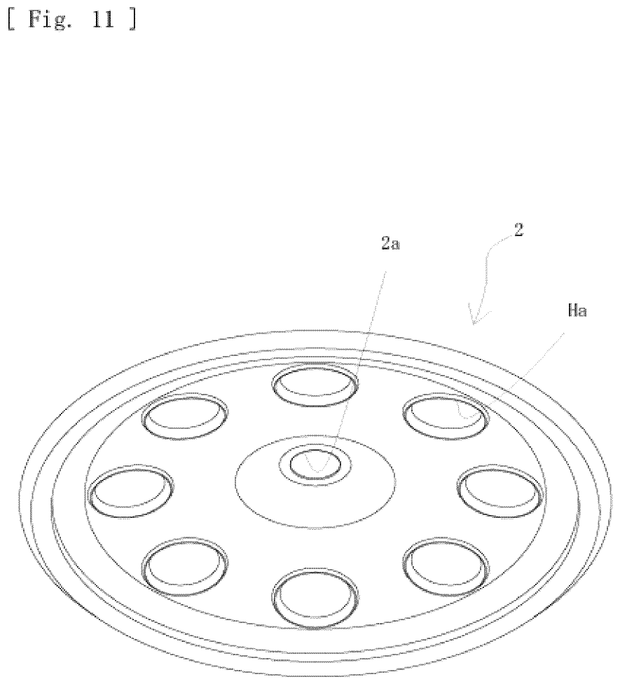

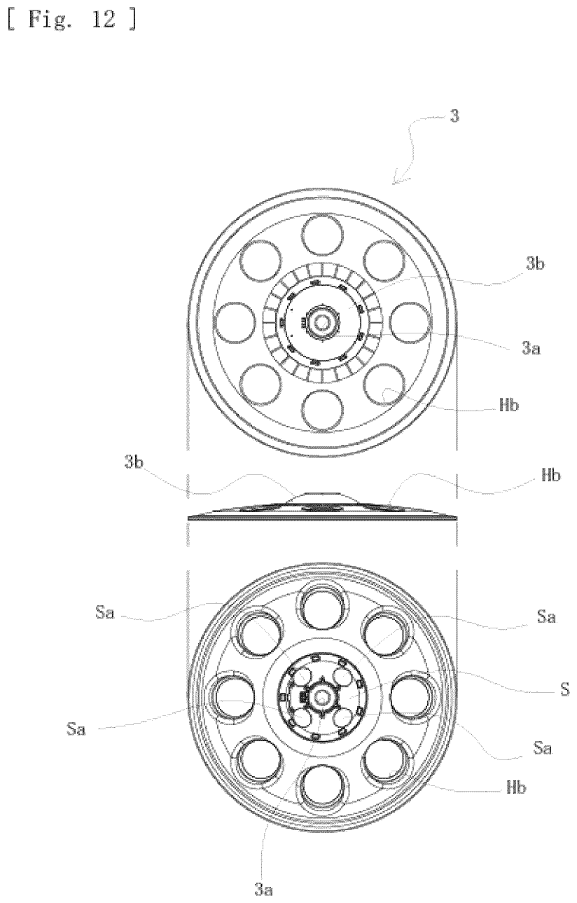

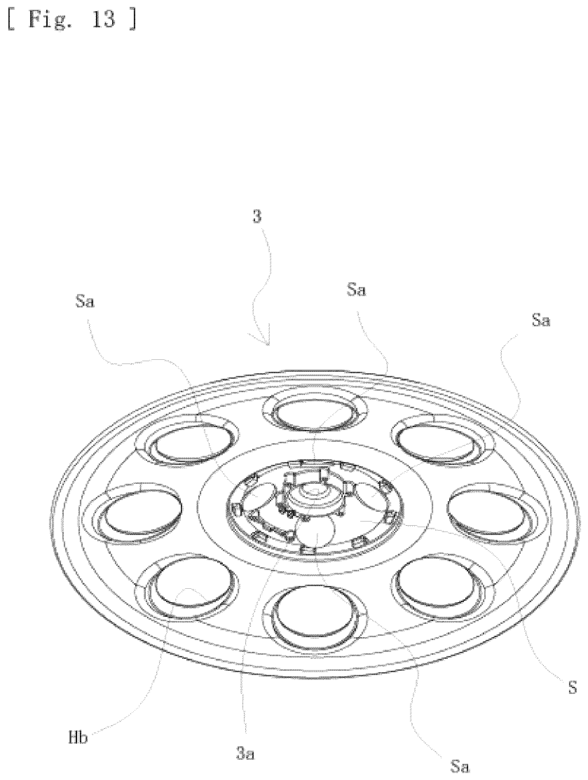

The frame 3 is made of a hard resin or a metal (ABS resin in the present embodiment). As illustrated in FIGS. 12 and 13, the frame 3 is comprised of a disk-shaped member with, at a center position, an insertion hole 3a that receives the supporting stand T. In addition, the pad 2 is mounted on and integrated with a front surface of the frame 3 into the body 1. A protruding portion 3b, that protrudes corresponding to the cup part Fb of the pad 2, is formed in a center portion of the frame 3.

In addition, mounting surfaces Sa, for mounting piezoelectric elements 4, are formed on the inner circumferential surface S of the protruding portion 3b in the frame 3. As illustrated in FIGS. 12 and 13, a plurality of (four in the present embodiment) mounting surfaces Sa are formed in a circumferential direction (circumference direction) on the inner circumferential surface S of the frame 3 in the body 1. A piezoelectric element 4 is to be mounted on each mounting surface Sa.

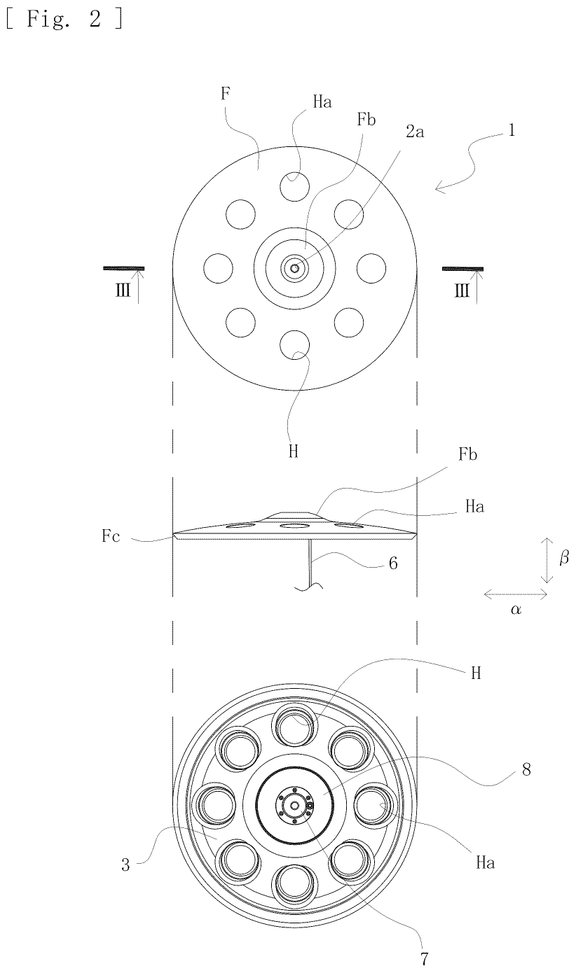

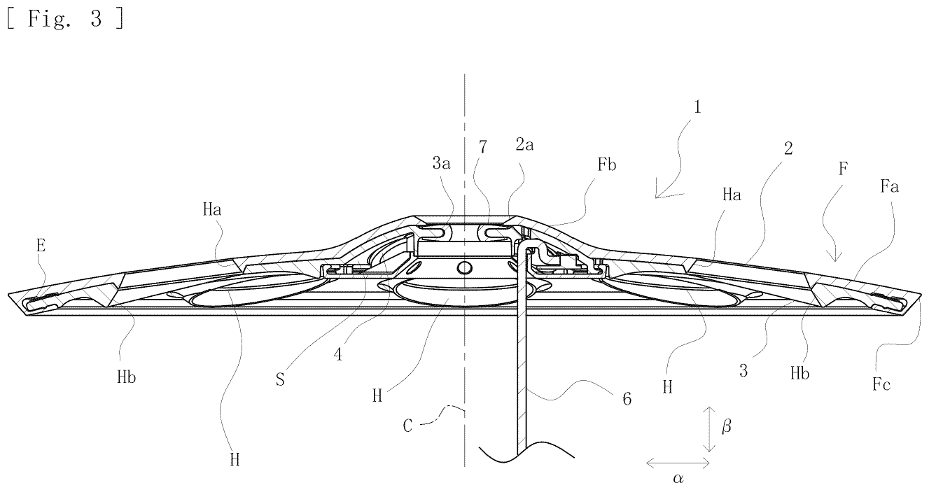

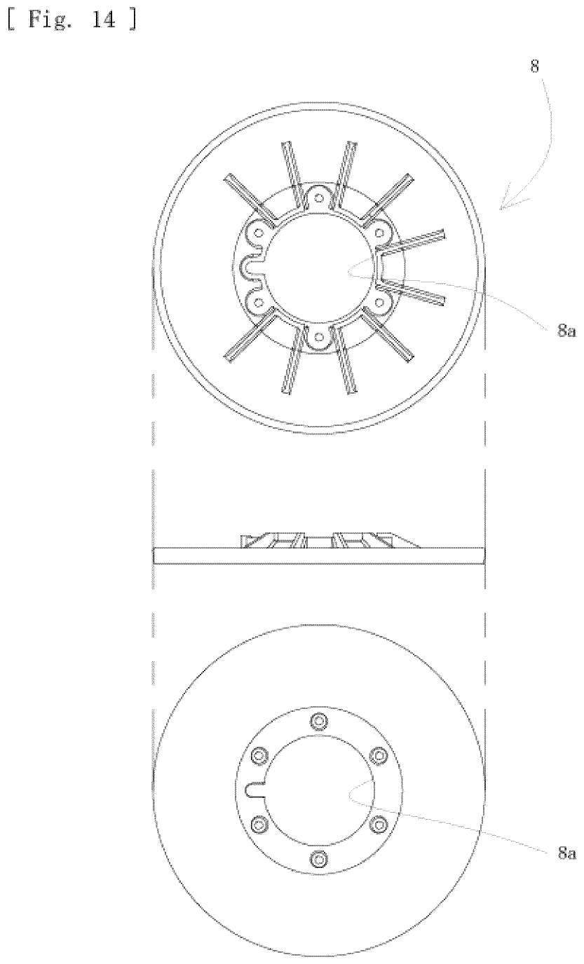

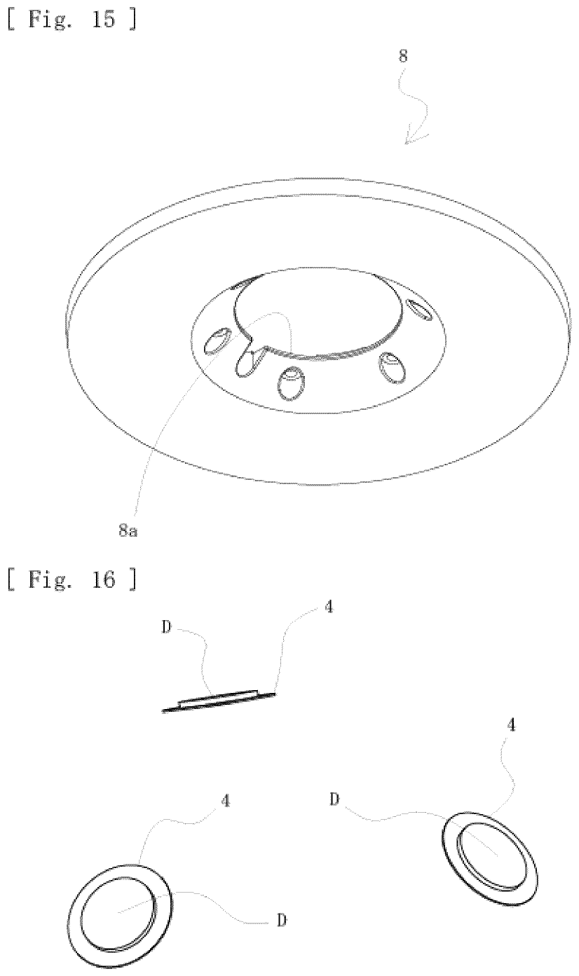

As illustrated in FIGS. 14 and 15, the covering member 8 includes a circular ring-shaped member with, at the center, an opening 8a that receives the supporting stand T. As illustrated in FIGS. 2 and 3, the covering member 8 is mounted so as to cover the inner circumferential surface S of the protruding portion 3b on the back surface side of the frame 3 and cover a substrate 5 (refer to FIGS. 3 to 6) where a predetermined electrical circuit is formed. The substrate 5 is electrically connected to the piezoelectric elements 4. A detection signal of each piezoelectric element 4 is transmitted to the substrate 5.

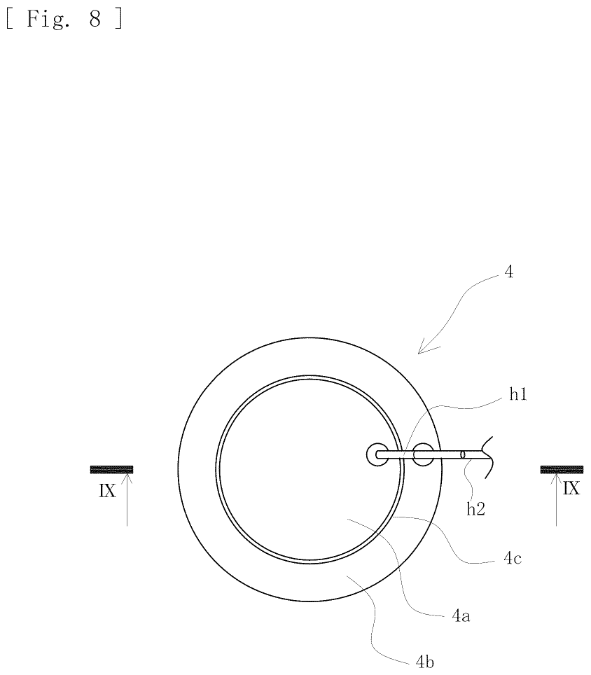

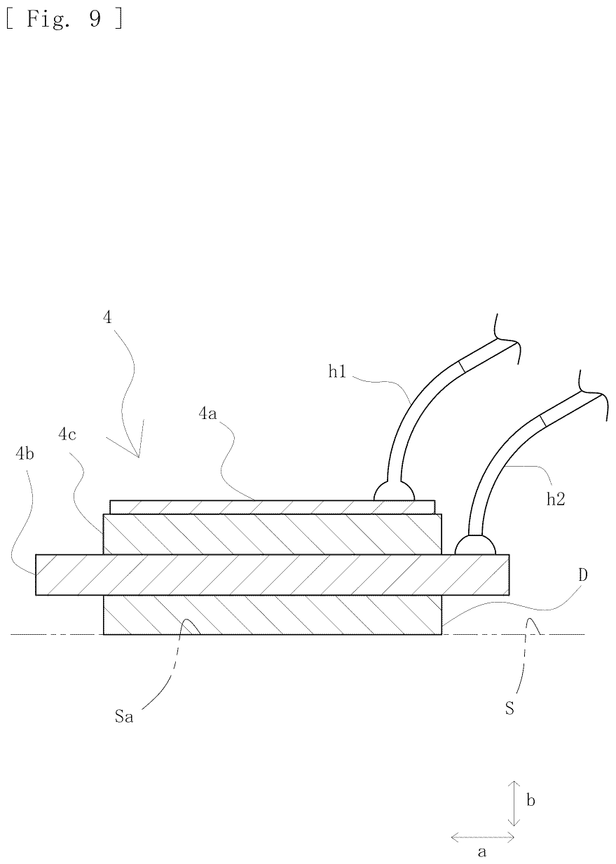

The piezoelectric element 4, as a vibration sensor, includes a sensor that is mounted on the mounting surface Sa formed in the body 1 (frame 3) with a buffer member D interposed between the piezoelectric element 4 and the mounting surface Sa. The buffer member D can convert vibration generated by a hit on the hitting surface F to an electrical signal. As illustrated in FIGS. 8 and 9, the piezoelectric element 4 includes: an upper electrode 4a made of silver conductor, a lower electrode 4b made of a brass plate, and a piezoelectric ceramic 4c interposed between the upper electrode 4a and the lower electrode 4b.

In addition, a wire h1 is connected to the upper electrode 4a. A wire h2 is connected to the lower electrode 4b. When a player hits the hitting surface F, and vibration is transmitted to the piezoelectric element 4, it is bent in its entirety due to the vibration. A voltage, corresponding to the amount of bending, is generated. When a voltage is generated in this manner, the upper electrode 4a functions as a positive electrode and the lower electrode 4b functions as a negative electrode. Thus, a current flows through the wires h1, h2, and the current is output through the substrate 5 and an output cable 6 as an electrical signal.

Meanwhile, the piezoelectric element 4 generates a voltage and outputs an electrical signal by being bent in direction (b) perpendicular to the mounting surface Sa. It has a structure unlikely to be bent in direction a parallel to the mounting surface Sa. Thus, it has higher output characteristics (output characteristics with a high voltage or a high current) in vibration in direction (b) perpendicular to the mounting surface Sa than in vibration in direction (a) parallel to the mounting surface Sa.

In the piezoelectric element 4 according to the present embodiment, the buffer member D has a cushion property. The buffer member D includes polyurethane foam attached to the bottom surface. As illustrated in FIG. 9, the surface of the buffer member D is bonded to the mounting surface Sa by adhesives or the like with the surface in close contact with the mounting surface Sa. In addition, the buffer member D is formed in a cylindrical shape. As illustrated in FIG. 9, it has an external shape, that is preferably about 67% of the diameter of the piezoelectric element, serving as a node of vibration of the piezoelectric element 4. Also, it has a dimension smaller than the outer diameter of the piezoelectric element 4 so that bending of the piezoelectric element 4 caused by vibration can be ensured.

Furthermore, an edge sensor E is attached to the circumferential edge of the front surface side of the frame 3 so that a hit on the edge part Fc in the pad 2 is detectable. As in the piezoelectric element 4, the edge sensor E is electrically connected to the substrate 5 through a wire. A detection signal is transmitted to the substrate 5. The output cable 6 is connected to the piezoelectric element 4 (vibration sensor) and the edge sensor E through the substrate 5. A detection signal detected by the piezoelectric element 4 and the edge sensor E can be output to the outside. Note that the output cable 6 is provided with an output jack J at its distal end. It is connectable to an external signal processing device (not illustrated).

When a player hits the hitting surface F of the pad 2 with a stick to vibrate the body 1, the strength of the hit is detected by the piezoelectric element 4. An electrical signal corresponding to the strength is output to an external signal processing device (not illustrated) through the output cable 6. A hit on the edge part Fc is identified according to an ON/OFF state of the edge sensor E. When a hit is detected with the edge sensor E in the OFF state, hitting on the bow part Fa or the cup part Fb is determined, and a predetermined music sound is output.

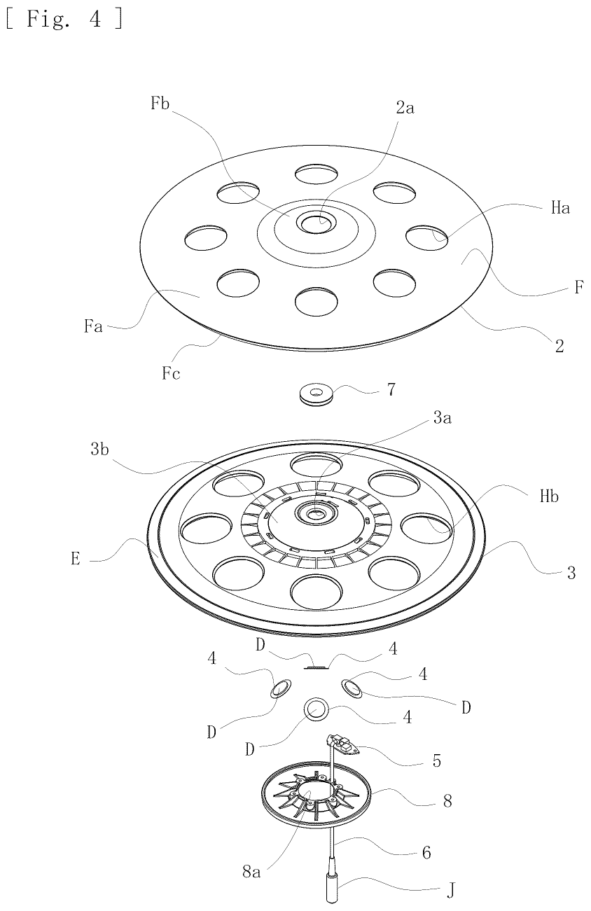

As illustrated in FIGS. 3 and 4, a shaft sleeve 7 includes a cylindrical elastic member (a rubber material in the present embodiment) with an insertion hole in a center portion. The shaft sleeve 7 is attached in the insertion hole 3a of the frame 3 while being interposed between the insertion hole 3a and the supporting stand T. Thus, vibration generated by a hit on the body 1 is prevented from being transmitted to the supporting stand T.

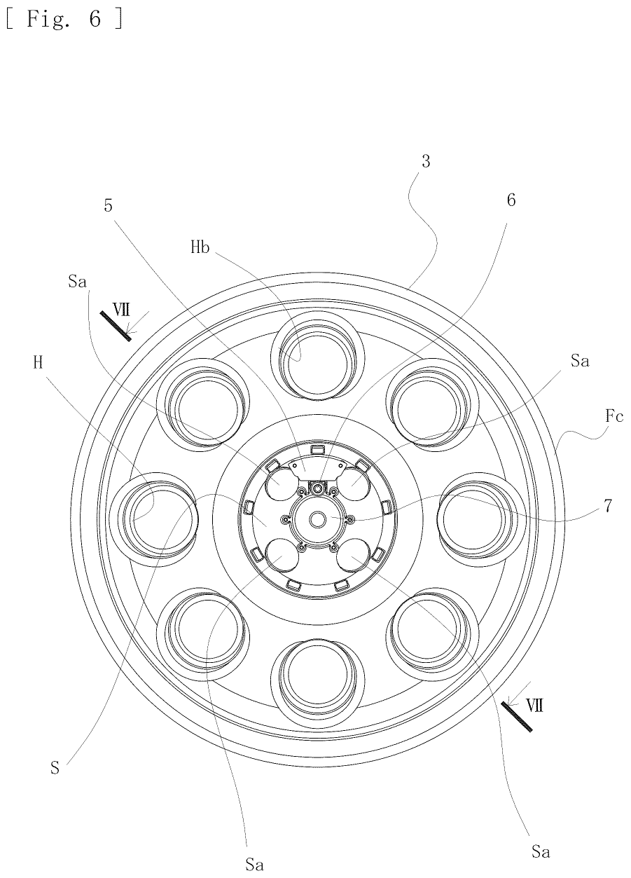

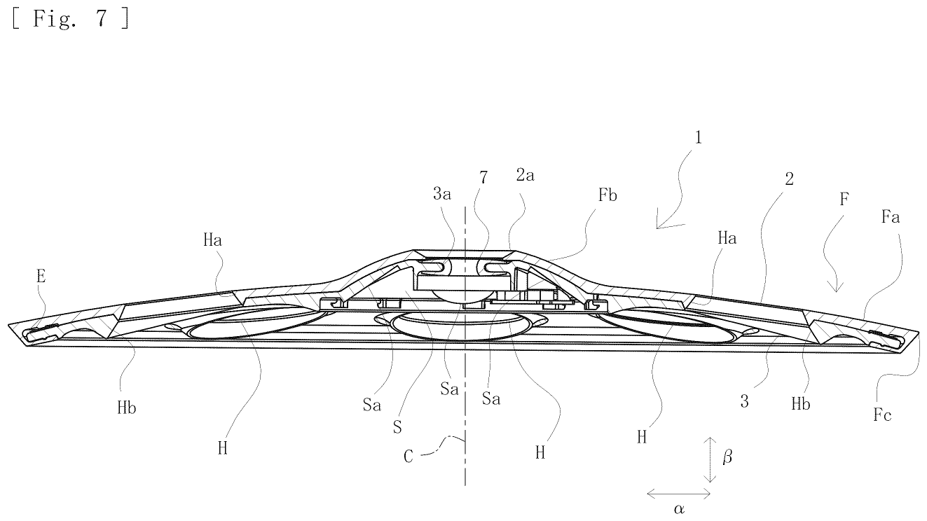

As illustrated in FIGS. 6 and 7, the mounting surfaces Sa according to the present embodiment, are formed of surfaces inclined from a horizontal plane (a plane including a horizontal direction α) to a vertical direction β toward the center of the body 1. The piezoelectric elements 4 are mounted on a concentric circle at regular intervals about the central axis C (refer to FIGS. 3 and 7) of the body 1. In other words, the inner circumferential surface S in the frame 3 of the body 1 is formed in a truncated conical shape. Thus, a plurality of (four in the present embodiment) mounting surfaces Sa are formed at regular intervals in a circumferential direction about the central axis C on the inner circumferential surface S. The piezoelectric elements 4 are mounted on the respective mounting surfaces Sa on a concentric circle.

A shape about the central axis C includes a predetermined region (a predetermined region on the inner circumferential surface or the outer circumferential surface) of the body 1 and is regarded as a virtual conical shape. A plurality of (four in the present embodiment) mounting surfaces Sa are formed on a concentric circle about the central axis C on the lateral surface (the sectorial surface of a developed view, the same applies to the following) of the virtual conical shape. The mounting surfaces Sa are inclined from a horizontal plane to the vertical direction β by a predetermined angle toward the center of the frame 3 in the body 1. Thus, the piezoelectric elements 4 can be arranged in a three-dimensional manner with the three dimensions formed by the horizontal direction α and the vertical direction β. Thus, it is possible to sufficiently bend the piezoelectric elements 4 by the vibration in either direction of the horizontal direction α or the vertical direction β. Consequently, an electrical signal can be output favorably and uniformly for the vibration both in the horizontal direction α and the vertical direction β caused by a hit on the hitting surface F.

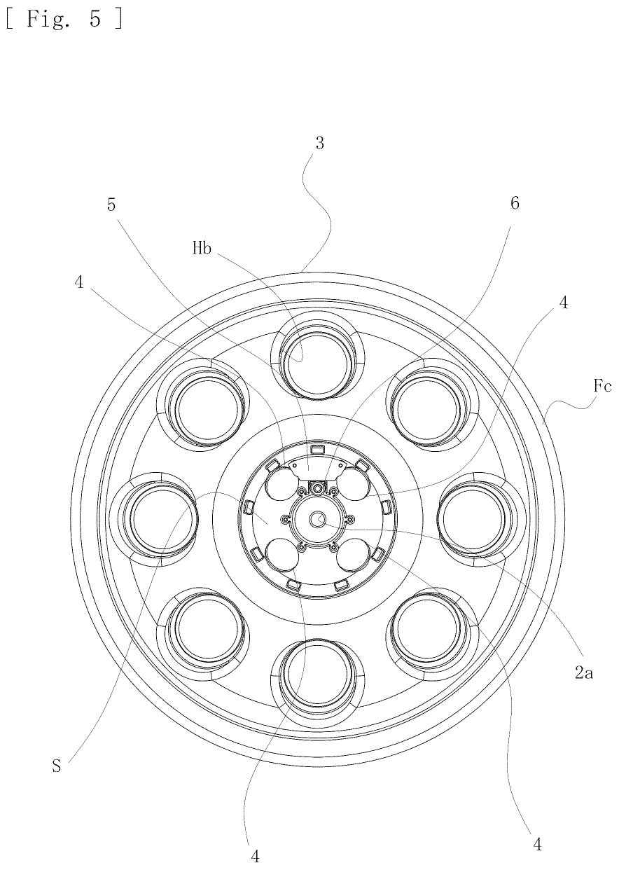

A shape about the central axis C includes a predetermined region of the body 1 and is regarded as a virtual conical shape. A plurality of (four in the present embodiment) mounting surfaces Sa are formed on a concentric circle about the central axis C on the lateral surface of the virtual conical shape. The mounting surfaces Sa, according to the present embodiment, are formed in a circumferential direction on the inner circumferential surface S of the frame 3 in the body 1. As illustrated in FIGS. 6 and 7, they are formed of planar surfaces (flat surfaces) corresponding to the mounting portions (the buffer members D in the present embodiment) of the piezoelectric elements 4. As illustrated in FIGS. 5 and 6, they have substantially the same shape (circular shape) and dimension (diameter dimension) of the external shape of each piezoelectric element 4. Note that the piezoelectric element 4 is not limited to the one having a circular external shape. It may have an elliptical shape or a rectangular shape, and even in that case, the mounting surface Sa has substantially the same shape as the external shape of the piezoelectric element 4.

The mounting surfaces Sa, in the present embodiment, are provided in a circumferential direction on the inner circumferential surface S of the frame 3 in the body 1. Thus, the mounting surfaces Sa may be provided in a circumferential direction on the outer circumferential surface (the surface of the protruding portion 3b) of the frame 3 in the body 1. Four piezoelectric elements 4, according to the present embodiment, are mounted on a concentric circle at regular intervals about the central axis C of the body 1. Three or more piezoelectric elements 4 are preferably mounted on a concentric circle at regular intervals about the central axis C of the body 1. For example, FIG. 16 illustrates a state where three piezoelectric elements 4 are arranged on a concentric circle at regular intervals. FIG. 17 illustrates a state where five piezoelectric elements 4 are arranged on a concentric circle at regular intervals.

According to the present embodiment, the mounting surfaces Sa are formed of surfaces inclined from a horizontal plane (a plane including the horizontal direction α) to the vertical direction β toward the center of the body 1. The piezoelectric elements 4 are mounted on a concentric circle at regular intervals about the central axis C of the body 1. Thus, even if the hitting surface F is hit in any of various directions, the hit can be stably and reliably converted to an electrical signal by the piezoelectric element 4 and the electrical signal can be output.

When three of more piezoelectric elements 4 are mounted on a concentric circle at regular intervals about the central axis C of the body 1, a hit on the hitting surface F can be stably converted to an electrical signal by the piezoelectric elements 4. The electrical signal can be uniformly output for hits in various directions. Furthermore, the mounting surface Sa is provided in a circumferential direction on the outer circumferential surface or the inner circumferential surface of the body 1. Thus, the piezoelectric elements 4 can receive the vibration caused by a hit on the hitting surface F more uniformly over the entire area of the hitting surface F. Thus, a variation in the output of electrical signal, due to a difference in hitting region, can be prevented.

In addition, the mounting surfaces Sa are formed in a circumferential direction on the outer circumferential surface or the inner circumferential surface of the body 1. They are formed of planar surfaces (flat surfaces) corresponding to the mounting portions (the buffer members D) of the piezoelectric elements 4. Thus, as compared to when fixing is made to a curved surface, the piezoelectric elements 4 can be stably fixed to the mounting surfaces Sa. Note that each mounting surface Sa is not limited to a planar surface. They be a curved surface that forms the inner circumferential surface S (or the outer circumferential surface).

In addition, the mounting surface Sa has substantially the same shape and dimension as the external shape of the piezoelectric element 4. Thus, at the time of mounting work of the piezoelectric element 4, the mounting position of the piezoelectric element 4 on the inner circumferential surface S of the body 1 can be accurately recognized. Thus, the positioning accuracy of the piezoelectric element 4 can be improved. Specifically, the piezoelectric element 4 is mounted corresponding to the mounting surface Sa. Thus, the positioning of the piezoelectric element 4 is automatically made, and the positioning accuracy can be improved.

Furthermore, the buffer member D is attached to the piezoelectric element 4. The buffer member D is brought into contact with and mounted on the mounting surface Sa. Thus, it is possible to prevent damage to the piezoelectric element 4 by the vibration generated by a hit. It is sufficient that the buffer member D has a cushion property and is attachable to the bottom surface of the piezoelectric element 4. Thus, the material and the shape are not limited.

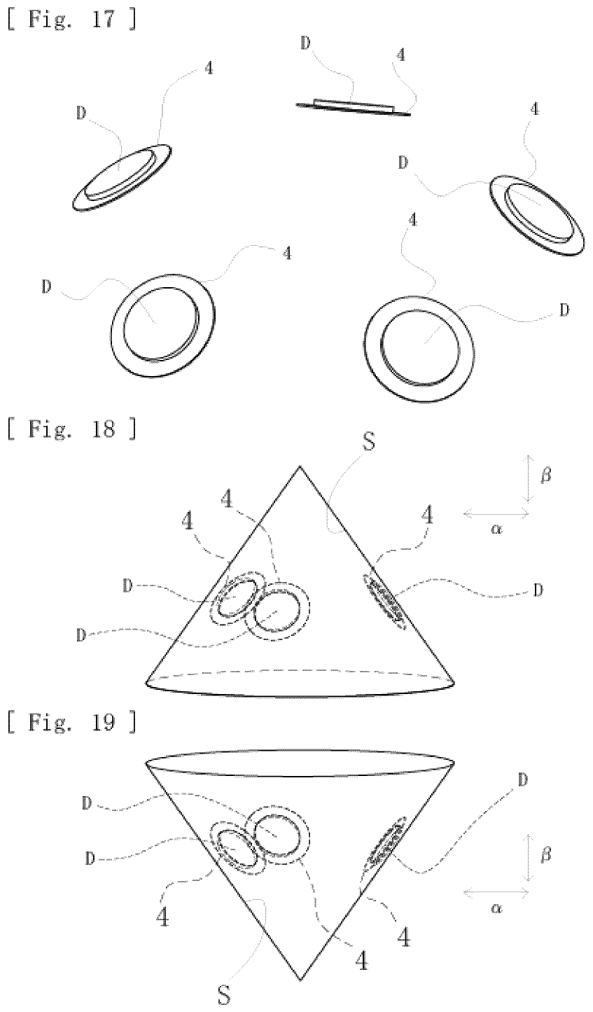

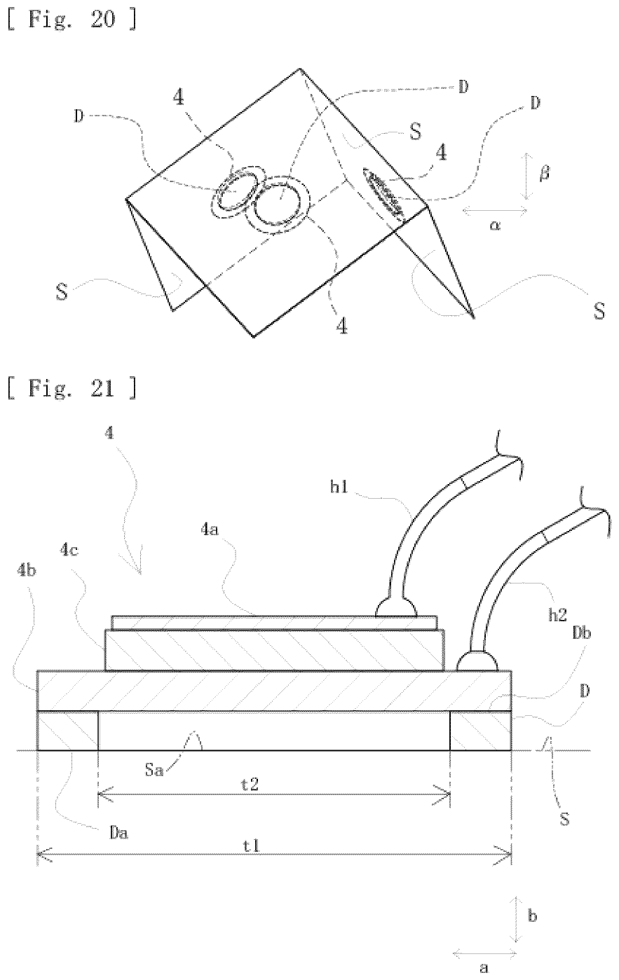

Although the present embodiments have been described so far, the present disclosure is not limited. For example, as illustrated in FIG. 18, a plurality of piezoelectric elements 4 may be disposed on a concentric circle in a circumferential direction of the inner circumferential surface S (or may be the outer circumferential surface) formed in a conical shape (truncated conical shape). In addition, as illustrated in FIG. 19, a plurality of piezoelectric elements 4 may be disposed on a concentric circle in a circumferential direction of the inner circumferential surface S (or may be the outer circumferential surface) formed in an inverted conical shape (truncated conical shape). Additionally, as illustrated in FIG. 20, a plurality of piezoelectric elements 4 may be disposed on a concentric circle in a circumferential direction of the inner circumferential surface S (or may be the outer circumferential surface) formed in a polyhedral shape.

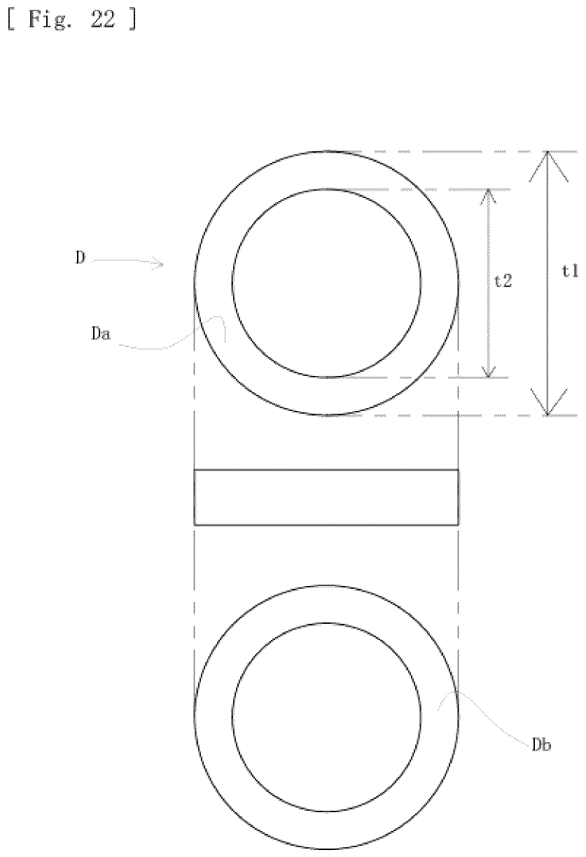

Furthermore, the buffer member D is not limited to the one in a cylindrical shape as in the embodiment. As illustrated in FIGS. 21 and 22, it may have a circular ring-shape. The back surface Db of the circular ring-shaped buffer member D is bonded to the bottom surface (lower electrode 4b) of the piezoelectric element 4 by adhesives or the like. The front surface Da is bonded to the mounting surface Sa by adhesives or the like. The circular ring-shaped buffer member D has a ring shape whose outer diameter dimension t1 is substantially equal to the outer diameter dimension of the piezoelectric element 4. Thus, the piezoelectric element 4 can favorably follow the bending of the body 1 while preventing excessive free vibration of the piezoelectric element 4 itself caused by a hit. Thus, the voltage of an electrical signal outputted can be ensured. Also, its attenuation is accelerated so that erroneous sound generation can be prevented. Furthermore, the buffer member D has a ring shape. Thus, free vibration can be ensured to some extent in an inner diameter region of the buffer member D and reduction in sensitivity upon a weak hit on the hitting surface F can be prevented.

Meanwhile, in the circular ring-shaped buffer member D, the inner diameter t2 of the internal hollow part is preferably 60 to 80% of the outer diameter t1. It is most preferable that the inner diameter t2 of the internal hollow part be 70% of the outer diameter t1. In the circular ring-shaped buffer member D, the front surface Da, to be in close contact with the mounting surface Sa, is a flat surface. A slit may be formed over part or all of the front surface Da or the ratio of the inner diameter t2 to the outer diameter t1 may be another ratio.

The body 1 includes the pad 2 and the frame 3. The mounting surfaces Sa are formed on the inner circumferential surface S of the frame 3. However, the mounting surfaces may be formed on the inner circumferential surface of a single body 1. In the present embodiment, the disclosure is applied to an electronic cymbal. However, it may be applied to another electronic percussion instrument such as an electronic drum with piezoelectric elements 4.

Aspects of the present disclosure are applicable to an electronic percussion instrument having a different exterior shape or an electronic percussion instrument to which another function is added as long as the mounting surfaces are formed of surfaces inclined from a horizontal plane to the vertical direction toward the center of the body. The piezoelectric elements are mounted on a concentric circle at regular intervals about the central axis of the body.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electronic percussion instrument comprising:
a body having a hitting surface that a player can hit;
piezoelectric elements are mounted on respective mounting surfaces formed in the body and are configured to convert vibration generated by a hit on the hitting surface to an electrical signal, and the piezoelectric elements have higher output characteristics in vibration in a direction perpendicular to the mounting surfaces than in vibration in a direction parallel to the mounting surfaces; and
the electronic percussion instrument outputs the electrical signal generated by the piezoelectric elements, and the mounting surfaces are formed of surfaces inclined from a horizontal plane to a vertical direction toward a center of the body, and the piezoelectric elements are mounted on a concentric circle at regular intervals about a central axis of the body.

2. The electronic percussion instrument according to claim 1, wherein the piezoelectric elements are more than two in number and mounted on a concentric circle at regular intervals about the central axis of the body.

3. The electronic percussion instrument according to claim 1, wherein when a shape about the central axis, including a predetermined region of the body, is regarded as a virtual conical shape, the mounting surfaces are formed on a concentric circle about the central axis on a lateral surface of the virtual conical shape, and the mounting surfaces are provided in a circumferential direction on an outer circumferential surface or an inner circumferential surface of the body.

4. The electronic percussion instrument according to claim 1, wherein the mounting surfaces are formed in a circumferential direction on an outer circumferential surface or an inner circumferential surface of the body, and include planar surfaces corresponding to mounting portions of the piezoelectric elements.

5. The electronic percussion instrument according to claim 4, wherein the mounting surfaces have substantially the same shape and dimension as an external shape of the piezoelectric elements.

6. The electronic percussion instrument according to claim 1, wherein a buffer member is attached to the piezoelectric elements, the buffer member is brought into contact with and mounted on a corresponding one of the mounting surfaces.
